(19) United States
(12) Patent Application Publication
(10) Pub. No.: US 2021/0230456 A1
(43) Pub. Date: Jul. 29, 2021

(54) ADHESIVE TAPE FOR BONDING LOW-ENERGY SURFACES

(71) Applicant: LOHMANN GMBH & CO. KG, Neuwied (DE)

(72) Inventors: Daniel GÄRTNER, Straßenhaus (DE); Jochen BRITZ, Urmitz/Rhein (DE); Patrik KOPF, Neuwied (DE)

(73) Assignee: LOHMANN GMBH & CO. KG, Neuwied (DE)

(21) Appl. No.: 17/265,447

(22) PCT Filed: Aug. 2, 2019
(86) PCT No.: PCT/EP2019/070909

§ 371 Date: Feb. 2, 2021

(30) Foreign Application Priority Data
Aug. 3, 2018 (DE) 10 2018 118 972.9

(51) Int. Cl. C09J 7/38; C09J 153/02; C09J 133/08

(52) U.S. Cl. CPC C09J 7/385; C09J 153/02; C09J 7/387; C09J 2493/00; C09J 2301/416; C09J 2301/30; C09J 133/08

(57) ABSTRACT

An adhesive tape for bonding low-energy surfaces, comprising a UV cross-linked pressure-sensitive adhesive compound which comprises poly-acrylate, a linear or branched vinyl aromatic block co-polymer and at least one adhesive resin. The UV cross-linking of the pressure-sensitive adhesive compound is the result of irradiation with UV-A-containing light.

### CROSS REFERENCE TO RELATED APPLICATIONS

This application is a national stage U.S. patent application of International Application No. PCT/EP2019/070909, filed on Aug. 2, 2019, and claims foreign priority to German Patent Application No. DE 10 2018 118 972.9, filed on Aug. 3, 2018, the entirety of each of which is incorporated herein by reference.

### TECHNICAL FIELD

The disclosure relates to an adhesive tape for bonding low-energy surfaces, comprising a UV-crosslinked pressure-sensitive adhesive compound, which comprises poly-acrylate, a linear or branched vinyl aromatic block co-polymer and at least one adhesive resin as well as a corresponding manufacturing method.

### DESCRIPTION OF THE RELATED TECHNOLOGY

Pressure-sensitive adhesive compounds based on solvent-free acrylate adhesive compounds are known in the art. The acrylate compounds are applied to a backing via a nozzle using a hot-melt process and subsequently cross-linked with UV-C light. Thus, a pressure-adhesive compound or a backing coated with a pressure-sensitive adhesive compound can be obtained that may operate as adhesive tapes.

Specifically, components are polymerised into acrylate polymers including photo-active side chains. Irradiation with UV light can be used to effect cross-linking of the acrylate polymers. The cross-linking ensures sufficient cohesion of the adhesive compound for the respective use case. In adhesives, the term cohesion refers to the forces that cause the adhesive to hold together, whereas adhesion refers to the strength of the adhesion of adhesive layers to the surfaces of the join partners. The coordinated ratio of cohesion and adhesion forces determines the strength of the respective adhesive bond in response to mechanical strain. The UV cross-linking process can also be referred to as curing. Prior to cross-linking, the semi-finished good is provided as a low-viscosity film. After cross-linking, the semi-finished good forms an adhesive tape.

Customarily, UV-C light is used for the cross-linking of acrylate adhesive compounds. UV-C light has a wavelength in the range of 200-280 nm, which covers the maximum absorption of the acrylate adhesive compounds. The generation of UV-C light uses relatively sophisticated UV lamps, provided in the form of discharge lamps. The use of discharge lamps is associated with the disadvantage that a relatively large amount of radiation heat is produced, which has to be deflected so as not to damage the material to be cross-linked. Yet another disadvantage is caused by the limited penetration depth of the UV-C radiation, which sets a limit for the maximum layer thickness of the semi-finished goods to be irradiated. The cross-linking process using unilateral irradiation reaches its limit at a layer thickness of 100 μm. If adhesive resins are added to the acrylate adhesive compound, which in many use cases provides a strong adhesive bond, the maximum coating thickness where a strong adhesive bond can be achieved is significantly reduced, as it is one characteristic of adhesive resins to absorb light in the UV-C range to a relatively large extent, thus negatively affecting cohesion. Without the adhesive resins, however, the bonding range and thus the range of application of the acrylate adhesive compounds is limited.

Today, mostly rosin esters (Fora) 85 E, Foral 105 E) are used for modifying the acrylate adhesive compounds.

### DESCRIPTION OF THE EMBODIMENTS

“Adhesive tape” hereinafter shall relate to any type of spatial adhesive systems, i.e. adhesive tapes, adhesive films, adhesive strips, adhesive plates or adhesive stamped parts.

“Pressure-sensitive adhesive” shall relate to adhesive bonds where the two join partners are bonded together by way of an intermediary adhesive layer and subject to pressure. The bond is reversible in that it can be released again without damaging the two join partners, because the adhesive seam is the weakest link in the adhesive bond.

“UV-cross-linking” shall relate to a process where, using high-energy irradiation, reactive materials are conveyed from a low-molecular to a high-molecular state.

In the case in hand, UV (ultra-violet) radiation is understood to be “UV-A” or “UV-C” light. UV-A radiation is in a wavelength range of ca. 315 to 400 nanometres (nm), UV-C radiation is in a wavelength range of ca. 200 to 280 nm. Generally, both constitute electromagnetic radiation at wavelengths shorter than visible light. For UV-A light, the energy input is ca. 3.26 to 3.95 electron volts (eV), for UV-C light, the energy input is ca. 4.43 to 12.40 eV.

The “Gardner color scale” represents a reference table for the yellow tint of a resin.

It is an object of the present disclosure to provide an improved adhesive tape for bonding low-energy surfaces as well as a corresponding manufacturing method.

The object specified above is achieved by an adhesive tape for bonding low-energy surfaces utilising the features of claim 1. Advantageous further developments derive from the dependent claims.

Accordingly, an adhesive tape for bonding low-energy surfaces is suggested, comprising a UV crosslinked pressure-sensitive adhesive compound, comprising poly-acrylate, a linear or branched vinyl aromatic block co-polymer and at least one adhesive resin. According to the disclosure, UV-cross-linking of the adhesive compound is based on irradiation containing UV-A light.

Surprisingly, it turned out that successful cross-linking is effected by irradiation of the acrylate adhesive compound with UV-A light. This equates an unexpected technical effect in spite of the general preconception that cross-linking of acrylate adhesive compounds can only possibly be achieved with UV light in the range of the UV-C light wavelength. Prohibited n-π* transitions, however, cause additional absorption of UV-A light, achieving cross-linking at sufficient intensity.

Presently, prohibited n-π* transitions shall mean electronic incitations of non-binding orbitals (n orbitals) to anti-binding orbitals (π* orbitals), whereas these incitations are actually spin-prohibited but nonetheless made possible by a sufficiently high spin-orbit-coupling. n-π* transitions, as a general rule, use less energy for incitation than permissible the π-π* transitions, which account for the absorption maximum. According to statistical thermodynamics, n-π* transitions are not very likely to occur.

Irradiation of the acrylate adhesive compound with UV-A light is associated with various advantages.

Using UV-A light irradiation, higher penetration depths can be realised, as the UV-A light is less susceptible to absorption than UV-C light during penetration of the acrylate adhesive compound. Among other reasons, this is due to the fact that most resins are yellowish to yellow and will thus absorb light in the UV range. The shorter the UV light wavelength, the stronger the absorption. Therefore, the available selection of sufficiently transparent resins in the UV-A range is much larger than in the UV-C range. Apart from that, there exist light and colorless resins that are considered transparent in the UV-A range still, whereas in the UV-C range they may already appear as less transparent, thus allowing only reduced penetration depths, any more. Often, yellow resins (they include double-bonds and aromatic compounds and annellated aromatic compounds) turn into colorless resins by partial and full hydrogenation. Compared to UV-C light, UV-A light has high wavelengths in the range of 320-400 nm, thus allowing for the use of a wider range of adhesive resins.

Consequently, irradiation of the acrylate adhesive compound using UV-A light allows for larger amounts of adhesive resins to be added. In turn, this allows for the provision of adhesive tapes that allow for bonding on difficult surfaces, low-energy surfaces and/or Low Surface Energy (LSE) surfaces (i.e. low-energy surfaces like PTFE, PP or PE, which are difficult to bond using adhesives), which cannot be achieved using adhesive compounds based on acrylates only or with acrylate adhesive compounds including only little adhesive resin. Automotive paints or poly-ethylene surfaces are examples of such surfaces. Low-energy surfaces have a critical interfacial energy in the range of 15 to 45 mN/m. The interfacial energy can be determined using the measurement methods according to DIN 53 364 or ASTM 2578-84.

Accordingly, UV-A light is suited better to penetrate modified acrylate adhesive compounds that have, for example, been modified by adding adhesive resins.

To date, it had only been possible to modify the acrylate adhesive compounds using adhesive resins provided the adhesive resins are compatible with the acrylate adhesive compounds, i.e. when they are soluble in them. Only within the context of a homogeneous adhesive compound the adhesives could operate as tackifiers. To date, primarily rosins have been used in acrylate compounds (rosin ester, hydrogenated, disproportionated). These resins are relatively polar and therefore quite compatible with the polar acrylate adhesive compound. The bonding range of acrylate adhesive compounds modified in this manner is not very large, though.

This problem is also true for acrylate adhesive compounds in general, i.e. also for solvent-based acrylate adhesive compounds or hotmelt acrylates of other types (without UV cross-linking).

Acrylate caoutchouc blends offer particularly favourable bonding properties in connection with low-energy surfaces. Styrene block co-polymers (SBCs) are suitable caoutchoucs known in the art, for example. The acrylate phase and the SBC phase are provided separately. Both polar and non-polar resins can be used as resins. Currently, these blends are used for example in adhesive tapes for bonding to automotive paint.

Irradiation with UV-A light now also allows for providing modified acrylate adhesive compounds in the form of acrylate caoutchouc blends. This makes it possible to combine the advantages of the acrylate hotmelt adhesive compounds (easy coating due to absence of solvents, no large equipment, fast UV cross-linking) with the modification options of blends for example for bonding of demanding surfaces.

For the selection of adhesive resins in hand it turned out that especially non-polar adhesive resins deliver good results, such as, for example, poly-terpene resins in all variations or fully synthetic C5 and C9 resins in all variations. They offer fair compatibility with the caoutchouc and produce a caoutchouc phase that primarily accounts for the good adhesion properties. Blends are not homogeneous but consist in two phases: Acrylate+adhesive resins and caoutchouc+adhesive resins. The adhesive resins distribute according to compatibility, the polymers (acrylate, caoutchouc) do not mix.

In an embodiment, the adhesive compound of the adhesive tape is completely cross-linkable at a Gardner color scale rating of 1 to 2 to a depth of 150 μm with UV-A containing light. Accordingly, adhesive tapes up to a thickness of up to 150 μm are fully cross-linkable. Therefore, compared to adhesive tapes based on curing using UV-B, higher layer thicknesses can be fully cross-linked by one-sided irradiation. By way of double-sided irradiation, comparatively thicker adhesive tapes can be fully cross-linked.

In a further development, the adhesive compound has an application weight in the range of 20 g/m² to 150 g/m², preferably 70 g/m² and a Gardner color scale rating of 1 to 2. Such an adhesive compound can be fully cross-linked by irradiation with UV-A containing light. Therefore, compared to adhesive tapes based on curing using UV-B, higher layer thicknesses can be fully cross-linked by one-sided irradiation.

In yet another embodiment, the adhesive tape comprises 30-75 percent by weight of the UV-cross-linked adhesive compound, 2-40 percent by weight of the linear or branched vinyl aromatic block co-polymer and 4-40 percent by weight of the at least one adhesive resin.

In a further embodiment, the UV-crosslinked adhesive compound comprises a UV initiator polymerised into the poly-acrylate chain. The basic substance of the UV cross-linked adhesive compound may, for example, be a hotmelt acrylate. Due to the UV initiator polymerised in, the adhesive compound can be cured within just a few seconds using UV light. The product series acResin by the company BASF represents one example for UV-cross-linkable adhesive compounds including polymerised UV initiators.

In yet another embodiment, the vinyl aromatic block co-polymer comprises soft blocks comprising homo- and co-polymers of butadiene, isoprene, ethyl butadiene and partially or fully hydrogenated varieties thereof and hard blocks comprising homo- and co-polymers of styrene, alpha methyl styrene and their derivatives. Preferably, the hard block comprises poly-styrene, and the soft block comprises poly-isoprene or poly-butadiene.

In yet a further embodiment, the at least one adhesive resin may be of the group of the non-, partially, selectively or fully hydrogenated carbohydrate resins on the basis of C5, C5/C9 or C9 monomers and/or of the group of poly-terpene resins on the basis of alpha pinene and/or bete-pinene and/or delta-limonene, wherein the resins can also be derivatised with phenol. Mixtures of the above resins are possible as well. Partially or fully hydrogenated resins have a comparatively smaller Gardner color scale rating, which results in less absorption during UV cross-linking.

In yet another embodiment, the adhesive tape comprises anti-oxidants, fillers, dyes, rheological additives and/or UV protection agents.

In yet another further development, the adhesive compound is foamed. Compared to a similar non-foamed adhesive compound, a foamed adhesive compound will be thicker at identical weight. Hollow glass spheres can be mixed into a starter adhesive compound to produce a foamed adhesive compound. Alternatively, expanded micro-balloons can be mixed into the starter adhesive compound. Foaming of the adhesive compound is then effected subject to heat treatment.

The object specified above is moreover achieved by a method for producing an adhesive tape for bonding low-energy surfaces with the features of claim 8. Advantageous further developments of the method derive from the dependent claims and from the present description.

Accordingly, a method is suggested for producing an adhesive tape for bonding low-energy surfaces, comprising the following steps: a) melting of a vinyl aromatic block co-polymer and an adhesive resin; b) stirring the vinyl aromatic block co-polymer and the adhesive resin; c) adding a UV-cross-linkable adhesive compound for producing a blend; d) applying the generated blend of vinyl aromatic block co-polymer, adhesive resin and adhesive compound on a sheet material; and e) irradiating the blend, in particular with UV-A light to provide a UV cross-linked adhesive tape.

As outlined above in connection with the adhesive tape, irradiation of the acrylate adhesive compound with UV-A light effects successful cross-linking. The advantages described in combination with the adhesive tape are realised with the method specified above.

In a further development, the blend completely cross-links at a Gardner color scale rating of 1 to 2 to a depth of 150 μm with UV-A containing light. Therefore, compared to adhesive tapes based on curing using UV-B, higher layer thicknesses can be fully cross-linked by one-sided irradiation. By way of double-sided irradiation, comparatively thicker adhesive tapes can be fully cross-linked.

In yet a further embodiment, the UV-cross-linkable adhesive compound for complete cross-linking of the blend using UV-A containing light has an application weight in the range of 20 g/m² to 150 g/m², preferably of 70 g/m², and the blend has a Gardner color scale rating of 1 to 2. Therefore, compared to adhesive tapes based on curing using UV-B, higher layer thicknesses can be fully cross-linked by one-sided irradiation.

In yet another embodiment, the photon energy of the irradiation amounts to 3.26 to 3.94 eV.

In a further embodiment, for application according to step a), the vinyl aromatic block co-polymer and the adhesive resin are melted at a temperature between 70-170° C., preferably 80-160° C. The above temperature range allows for melting the blend whilst simultaneously preventing gelling of the components.

In yet another embodiment, LEDs are used to irradiate the blend with UV-A light. Compared to discharge lamps, which are used for irradiation with UV-C light, LEDs offer a much higher degree of efficiency. Moreover, LED UV systems provide high irradiation intensity whilst emitting only little heat.

In a further development, the method is solvent-free. Therefore, the method can be implemented relatively environmentally friendly and at low cost.

### DETAILED DESCRIPTION OF EMBODIMENTS

Sample embodiments of the present disclosure are described in connection with the description of the test-set-up outlined below.

Shear Strength Test (SAFT):

A sample strip (width: 25 mm) consists of an adhesive compound layer laminated onto an etched PET film (thickness: 50 μm). The sample strip is glued onto a stainless steel plate (previously cleaned with benzine) in an overlapping pattern to create a bonded surface of 25 mm×25 mm. Subsequently, the sample strip is pressed securely onto the surface using a spatula. The sample strip is vertically subjected to a weight of 1 kg, and this arrangement is suspended in a convection oven. Subsequent heat treatment starts at a temperature of 40° C. and is increased to 160° C. at 0.5 K/min. The test result is concluded by the temperature where the sample strip drops off. If the strip does not drop off at 160° C., the result is over 160° C. The value indicated corresponds to the mean value of three measurements.

### Peel Strength on Steel and Poly-Ethylene (PE):

The 180° peel strength measurement is performed in accordance with DIN ISO 1939 at standard atmosphere conditions (23° C., 50% relative humidity). A substrate is wiped off with a cloth soaked with benzine. Once the benzine has evaporated, a sample strip of a width of 25 mm is applied onto the substrate (adhesive compound laminated onto an etched PET film, thickness: 50 μm). Then, a roller (weight: 5 kg) is run twice across the sample strip (5 m/min). The specimen thus produced is conditioned at standard atmosphere conditions (23° C., 50% humidity) for 24 hours . Then, the force is measured that has to be exerted at a peel-off angle of 180° at a speed of 300 mm/min in order to peel the sample strip off of the substrate. The value indicated corresponds to the mean value of three measurements.

For example, stainless steel (according to the Afera standard 4001) or poly-ethylene (test plates by the company Rocholl) can be used as a substrate.

After the peel strength measurement, the fracture pattern is evaluated. In this context, AF stands for adhesion fracture with the substrate, CF stands for cohesion fracture and AFCa stands for adhesion fracture with the etched PET film. If the fracture pattern is CF, i.e. when the adhesive compound is fractured in itself, this indicates insufficient cross-linking of the adhesive compound.

90° Peel Strength on Painted Metal Sheets:

The 90° peel strength measurement on painted metal sheets is performed in accordance with DIN ISO 1939 at standard atmosphere conditions (23° C., 50% relative humidity). The painted metal sheet consists in a metal sheet with a three-layer paint structure: filler, base paint and clear varnish: 2K-clear varnish Supermar by the company Axalta, drying conditions: 20 min at 140° C.

The sample strip is a PE foam adhesive tape, having a poly-ethylene foam as the backing (Alveolit TMA SRZ 801 by the company Sekusui Alveo), which is pre-treated with corona irradiation on both sides and that the adhesive film is laminated onto (application weight: 70 g/m², on siliconised PET film).

The painted metal sheet is wiped off with a cloth soaked with benzine. Once the benzine has evaporated, one side of the sample strip of (width: 25 mm) is applied after removing the siliconised PET film. The PET film on the rear side is replaced by a non-siliconised, etched PET film (thickness: 50 μm). Then, a roller is run over the compound (weight: 5 kg, 5 m/min). The specimen is conditioned at standard atmosphere conditions (23° C., 50% humidity) for 24 hours, then the force is measured that has to be exerted at a peel-off angle of 90° at a speed of 100 mm/min in order to peel the sample strip or the adhesive tape off of the substrate. The value indicated corresponds to the mean value of three measurements.

After measuring, the fracture pattern is evaluated. Here, AF stands for adhesion fracture in respect of the paint.

Gardner Color Scale:

The Gardner color scale provides a reference table for the yellow tint of resin. A corresponding Gardner color scale ranges from 1 to 18 and is either determined by means of a color comparison with cobalt chloride solutions of different concentrations or by means of spectroscopic methods according to DIN EN 4630 at 380-720 nm. 1 means crystal clear, 3 is slightly yellow, 5 is yellow to amber colored. Significant yellow tint in the visible range may also be taken into account as a point of reference for the absorption of UV light in the UV-A range (320 to 400 nm) to determine the degree of absorption due to its spectral vicinity. Adhesive resin manufacturers provide the Gardner color scale rating of a solution of the resin in toluene (50%) in the data sheet. A significant difference can be seen in particular between the color reference ratings 4 and 5. Whilst color reference rating 4 still results in yellow-tinted adhesive compounds, resins associated with the reference rating 5 already produce noticeably darker adhesive compounds.

### Materials

| | | Gardner | |
|---|---|---|---|
| product name | brief description | color scale | company |
| acResin 204 UV | UV acrylate hotmelt, based on EHA and BA | crystal clear | BASF SE |
| Kraton D 1161 | linear SIS, 15% styrene share, 17% diblock | crystal clear | Kraton |
| | share | | |
| Dercolyte A 115 | poly-terpene resin based on α-pinene | 5 | DRT |
| Piccolyte S 115 | poly-terpene resin based on β-pinene | 4 | Pinova |
| Sylvares 6100 | poly-terpene resin, styrene modified, end | 3 | Kraton |
| | block resin | | |
| Sylvares TR M 115 | poly-terpene resin | 3 | Kraton |
| Regalite R 1090 | carbohydrate resin, hydrogenated | 1 | Eastman |
| Regalite R 1125 | carbohydrate resin, hydrogenated | 1 | Eastman |
| Novares PURE 85 | carbohydrate resin, aromatic | 1 | Rütgers |
| AS | | | Novares |
| Foral 85 E | Colophony ester resin, hydrogenated | 2 | Eastman |

Production of the Adhesive Compounds and Coating

In an aluminium container set into a heating block, a styrene block co-polymer and resin are melted and stirred at a temperature of 165° C. until a uniform, clear melt is formed. Subsequently, it is cooled down to 150° C., and UV acrylate hotmelt is added until a quasi-homogeneous white mixture is formed.

The mix is coated onto siliconised polyester film in a hotmelt coating device between two rollers (temperature: 145° C.). The gap setting between the two rollers is selected such that the resulting application amount is 70 g/m². The coating step is followed by a cooling step. A cloudy transfer film is obtained, which is used for measuring. The clouding shows that it is a blend adhesive compound. Subsequently, the transfer films are irradiated under UV light. Two types of irradiation are carried out:

UV-C: Irradiation with a UV mini laboratory dryer BE 7/1 laboratory irradiation device by the company Beltron. Set at full UV intensity, belt speed: 6 m/min.

UV-A: Irradiation in a Honle LEDcube100 irradiation chamber with a Honle LEDpowerdrive 40 controller, wavelength 365 nm, duration: 20 seconds.

The irradiation intensities in both devices are measured using the same UV measurement device, i.e. the Power Puck II by the company EIT Instrument Markets Group. In this, the intensities were measured separately for UV-C, UV-B and UV-A. The different irradiations for the durations listed resulted in the following intensities:

| intensities according to | | | |
|---|---|---|---|
| Power Puck II in | | | |
| mJ/cm² | UV-C | UV-B | UV-A |
| UV-A | 0 | 0 | 3738 |
| UV-C: | 58 | 192 | 216 |

The examples B1 to B5 show the adhesive compound compositions of the different specimens:

| amounts | | | | | |
|---|---|---|---|---|---|
| specified in | | | | | |
| percent | | | | | |
| by weight | B1 | B2 | B3 | B4 | B5 |
| UV acrylate | acResin | acResin | acResin | acResin | acResin |
| hotmelt | 204 UV | 204 UV | 204 UV | 204 UV | 204 UV |
| | 52% | 52% | 52% | 52% | 52% |
| styrene | Kraton D | Kraton D | Kraton D | Kraton D | Kraton D |
| block | 1161 | 1161 | 1161 | 1161 | 1161 |
| copolymer | 19.5% | 19.5% | 19.5% | 19.5% | 19.5% |
| adhesive | Sylvares | Sylvares | Sylvares | Sylvares | Regalite R |
| resin 1 | 6100 | 6100 | 6100 | 6100 | 1090 |
| | 4% | 4% | 4% | 4% | 14.25% |
| adhesive | Regalite R | Piccolyte | Novares | Sylvares | Regalite R |
| resin 2 | 1090 | S 115 | PURE 85 | TR M115 | 1125 |
| | 12.25% | 24.5% | AS | 24.5% | 14.25% |
| | | | 24.5% | | |
| adhesive | Regalite R | | | | |
| resin 3 | 1125 | | | | |
| | 12.25% | | | | |

The examples B1 to B5 are compared to the comparative samples VB1 to VB3. Specimens of the comparative samples VB1 to VB3 have the following formulation:

| amounts specified in | | | |
|---|---|---|---|
| percent by weight | VB1 | VB2 | VB3 |
| UV acrylate hotmelt | acResin 204 | acResin 204 | acResin 204 |
| | UV | UV | UV |
| | 100% | 80% | 52% |
| styrene block co- | | | Kraton D |
| polymer | | | 1161 |
| | | | 19.5% |
| adhesive resin 1 | | Foral 85 E | Sylvares |
| | | 20% | 6100 |
| | | | 4% |
| adhesive resin 2 | | | Dercolyte A |
| | | | 115 |
| | | | 24.5% |

Test Results

Following irradiation of the specimens with UV-A light or UV-C light, the shear strength (SAFT) of the examples B1 to B5 and the comparative samples VB1 and VB3 showed the following values (specimens=transfer films):

| | Irradiation type | SAFT in ° C. |
|---|---|---|
| B1 | UV-C | 46 |
| B1 | UV-A | >160 |
| B2 | UV-C | 40 |
| B2 | UV-A | >160 |
| B3 | UV-C | 40 |
| B3 | UV-A | 124 |
| B4 | UV-C | 40 |
| B4 | UV-A | 104 |
| B5 | UV-C | 46 |
| B5 | UV-A | >160 |
| VB1 | UV-C | >160 |
| VB1 | UV-A | >160 |
| VB2 | UV-C | 40 |
| VB2 | UV-A | 94 |
| VB3 | UV-C | 40 |
| VB3 | UV-A | 54 |

Following irradiation of the specimens with UV-A, the peel strength on steel and polyethylene, respectively, showed the following values (specimens=transfer films):

| | | peel strength | | peel strength | |
|---|---|---|---|---|---|
| | | on steel | fracture | on PE | fracture |
| | Irradiation type | [N/2.5 cm] | pattern | [N/2.5 cm] | pattern |
| B1 | UV-A | 46 | AF | 27 | AF |
| B2 | UV-A | 31 | AFCa | 16 | AF |
| B3 | UV-A | 47 | AFCa | 15 | AF |
| B4 | UV-A | 36 | AFCa | 10 | AF |
| B5 | UV-A | 38 | AFCa | 21 | AF |
| VB1 | UV-A | 29 | AF | 8 | AF |
| VB2 | UV-A | 40 | CF | 7 | CF |
| VB3 | UV-A | 45 | AFCa | 37 | CF |

The values of the 90° peel strength on painted metal sheets of the examples B1 and VB1 derive from the table copied in below (specimens=PE foam adhesive tape):

| | | Peel strength | |
|---|---|---|---|
| | | on painted | |
| | | metal sheets | fracture |
| | Irradiation type | [N/2.5 cm] | pattern |
| B1 | UV-A | 65 | AF |
| VB1 | UV-A | 24 | AF |

In the examples B1 to B5, the irradiation with UV-C results in low SAFT values of about 40° C. This shows that the adhesive compounds were not, or in any case only hardly, cross-linked subject to this irradiation. The adhesive bond may slide off much more easily when weight is applied.

The SAFT values are much higher subject to irradiation under UV-A conditions (above 100° C. to 160° C.). This indicates that the adhesive compound was cross-linked by the irradiation.

In the comparative samples VB2 and VB3, also under UV-A conditions only low SAFT below 100° C. values are realised, i.e. no sufficient cross-linking is achieved. This can also be seen from the CF fracture pattern in the peel strength on steel and poly-ethylene.

The comparative sample VB1, which includes a pure acrylate hotmelt adhesive compound, does cross-link subject to UV-A light (high SAFT value), the peel strengths on low-energy surfaces such as poly-ethylene or painted metal sheets, however, are much less than in the examples B1 to B5.

Comparative sample VB3 involves a strongly yellow-tinted resin with a Gardner color scale rating of 5. Here, no cross-linking occurs even under UV-A conditions. This is because the UV light cannot penetrate deeper due to the heavy tint and therefore fails to effect cross-linking.

Sample B1 cross-links very well subject to UV-A irradiation and exhibits high peel strength on poly-ethylene and painted metal sheets.

It turns out that the formulations B1 to B5 can be sufficiently cross-linked using UV-A light irradiation and that therefore the adhesive tapes that can be generated in this fashion offer very favourable bonding strengths on low-energy surfaces.

As far as applicable, all individual features shown in the sample embodiments can be combined and/or exchanged without leaving the scope of the disclosure.

1. An adhesive tape for bonding low-energy surfaces, comprising
a UV-cross-linked pressure-sensitive adhesive compound, comprising poly-acrylate,
a linear or branched vinyl aromatic block co-polymer, and
at least one adhesive resin,
wherein the UV cross-linked pressure-sensitive adhesive compound adaped to be cross-linked as a result of irradiation with UV-A-containing light.

2. The adhesive tape of claim 1, wherein the cross-linked pressure-sensitive adhesive compound of the adhesive tape is cross-linkable at a Gardner color scale rating of 1 to 2 to a depth of 150 μm with UV-A-containing light.

3. The adhesive tape of claim 1 wherein the cross-linked pressure-sensitive adhesive compound has an application weight in the range of 20 g/m² to 150 g/m² and a Gardner color scale rating of 1 to 2.

4. The adhesive tap of claim 1, wherein the adhesive tape further comprises
30-75 percent by weight of the UV cross-linked pressure-sensitive adhesive compound,
2-40 percent by weight of the linear or branched vinyl aromatic block co-polymer, and
4-40 percent by weight of the at least one adhesive resin.

5. The adhesive tape of claim 1, wherein the UV cross-linked pressure-sensitive adhesive compound comprises a UV initiator polymerised into the poly-acrylate chain.

6. The adhesive tape of claim 1, wherein the vinyl aromatic block co-polymer comprises:
soft blocks comprising homo- and co-polymers of butadiene, isoprene, ethyl butadiene and partially or fully hydrogenated varieties thereof,
and hard blocks comprising homo- and co-polymers of styrene, alpha methyl styrene and their derivatives.

7. The adhesive tape of claim 1, wherein the adhesive resins comprises a hydrocarbon resin, a poly-terpene resin, or both limonene, wherein the resins can be derivatised with phenol.

8. The adhesive tape of claim 1, wherein the crosslinked adhesive tape comprises anti-oxidants, fillers, dyes, rheological additives, or UV protection agents, or any combinations thereof.

9. The adhesive tape of claim 1, wherein the cross-linked pressure-sensitive adhesive compound is adapted to be foamed.

10. A method for producing an adhesive tape for bonding low-energy surfaces, the method comprising:
a) melting of a vinyl aromatic block co-polymer and an adhesive resin;
b) stirring the vinyl aromatic block co-polymer and the adhesive resin;
c) adding a UV cross-linkable pressure-sensitive adhesive compound for producing a blend;
d) applying the generated blend of vinyl aromatic block co-polymer, adhesive resin and pressure-sensitive adhesive compound on a sheet material; and
e) irradiating the blend with UV-A-containing light to provide a UV cross-linked adhesive tape.

11. The method of claim 10, wherein the blend is completely cross-linked at a Gardner color scale rating of 1 to 2 to a depth of 150 μm with UV-A containing light.

12. The method of claim 10, wherein a complete cross-linking of the blend is obtained using a UV-A-containing light; and the UV cross-linkable pressure-sensitive adhesive compound has an application weight in the range of 20 g/m² to 150 g/m²; and the blend has a Gardner color scale rating of 1 to 2.

13. The method claim 1, wherein a photon energy of the irradiation amounts to 3.26 to 3.94 eV.

14. The method claim 1, wherein the melting of the vinyl aromatic block co-polymer and the adhesive resin is at a temperature between 80-160° C.

15. The method of claim 1 wherein the method for producing the adhesive tape is solvent-free.

16. The adhesive tape of claim 3, wherein the cross-linked pressure-sensitive adhesive compound has an application weight in the range of 70 g/m².

17. The adhesive tape of claim 7 wherein the hydrocarbon resin comprises hydrocarbon resin selected from the group consisting essentially of a non-hydrogenated carbohydrate resin, a partially hydrogenated carbohydrate resin, a selectively hydrogenated carbohydrate resin, a fully hydrogenated carbohydrate resin; a C5 monomer resin, a C5/C9 monomer resin, and a C9 monomer resin.

18. The adhesive tape of claim 7, wherein the poly-terpene resin comprises a poly-terpene resin selected from the group consisting essentially of an alpha pinene resin, a beta-pinene resin, and a delta-limonene.

19. The method of claim 3, wherein the cross-linked pressure-sensitive adhesive compound has an application weight in the range of 70 g/m².
